(19) United States
(12) Patent Application Publication
(10) Pub. No.: US 2008/0273777 A1
(43) Pub. Date: Nov. 6, 2008

(54) Methods And Apparatus For Segmentation And Reconstruction For Endovascular And Endoluminal Anatomical Structures

(76) Inventors: Vincent Luboz, Cambiac (FR); Xunlei Wu, Quincy, MA (US); Karl Krissian, Perpignen (FR); Stephane M. Cotin, Belmont, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/067,257

(22) PCT Filed: Oct. 19, 2006
(86) PCT No.: PCT/US06/40952

§ 371 Date: Mar. 18, 2008

Related U.S. Application Data
(60) Provisional application No. 60/729,280, filed on Oct. 21, 2005.

(51) Int. Cl. G06K 9/00

(52) U.S. Cl. 382/130

(57) ABSTRACT

Methods and apparatus for generating network of endoluminal surfaces by defining a set of medial axes for a tubular structure, defining a series of cross sections along medial axis in the set of medial axes, generating a connectivity graph of the medial axes, defining multiple surface representations based upon the graph of the medial axes and the cross sections, computing a volume defined by a first one of the surface representations, defining a partition of the medial axis, cross-sections, surface and/or volume representations, and outputting the network of endoluminal surfaces.

### STATEMENT REGARDING FEDERALLY SPONSORED RESEARCH

The U.S. Government may have certain rights in the invention pursuant to the US Department of Defense grant DAMD 17-02-2-0006, as amended with funds from Research Area Directorate II/Combat Casualty Care.

### BACKGROUND

As is known in the art, there are a variety of known elementary segmentation and reconstruction techniques available on medical imaging systems that rely on simple thresholding techniques or volumetric reconstruction techniques. Such systems retain pixels within a medical image of a certain intensity interval and reconstruct a model corresponding to these isolated pixels. One disadvantage of these techniques is that they generate relatively rough surfaces, discontinuities, missed critical pixels, and therefore, small endoluminal structures. Nevertheless, these methods are computationally efficient and give a rough estimation of the size and the location of a possible pathological condition. However, this level of estimation is not adequate in certain applications.

Further known segmentation techniques tend to be replaced by several others presented in the literature, which techniques can be divided into two approaches:
techniques for centerline enhancement, including multi-scale approaches, usually based on the Hessian matrix; and
techniques for contour extraction, including statistical approaches: Expectation Maximization (see. e.g. Wells, W. M. and Grimson, W. E. L. and Kikinis, R. and Jolesz, Ferenc A., 1995. Adaptive Segmentation of MRI Data Springer-Verlag, 905, 59-69.), random Markov fields, and geometrical approaches: region growing, adaptive thresholding, active contours that can be explicit, like snakes, or implicit, like level sets (see e.g., Sethian, J. A., 1999. Level Set Methods and Fast Marching Methods: Evolving Interfaces in Comp. Geom., Fluid Mech., Comp. Vision and Materials Sci. Cambridge Univ. Press, and Suri, J. S., Liu, K., Singh, S., Laxminarayan, S. N., Zeng, X., Reden, L., 2002. Shape recovery algorithms using level sets in 2D/3D medical imagery: a state-of-the-art review IEEE Transactions on Information Technology in Biomedicine, 6, 8-28).
   These techniques usually perform better after noise reduction. A topological representation of the endoluminal network can be obtained from both approaches either by computing ridges or by applying a thinning technique like homotopic skeletonization.

Once a medical data set is segmented, an iso-surface can be formed through the extracted boundaries, for example through a marching cube algorithm (see e.g., Lorensen, W. E., Cline, H. E., 1987. Marching Cubes: A high resolution 3-D surface construction algorithm Computer Graphics, 21, 163-169) or a surface reconstruction algorithm. (see e.g., Bühler, K. Felkel P., La Cruz A., 2002. Geometric Methods for Vessel Visualization and Quantification—A Survey. VRVis Research Center, Austria, Technical Report, pp. 24-48) presents a comprehensive survey on these techniques. While the surfaces resulting from the above techniques are more accurate than the ones obtained with thresholding techniques, the remaining limitations in estimating anatomical structures provide obstacles in certain real world applications.

Additional known methods include U.S. Patent Publication No. US2003031351 to Yim et al, entitled “Vessel delineation in magnetic resonance angiographic images” and U.S. Patent Publication No. US2002136440 to Yim et al, entitled “Vessel surface reconstruction with a tubular deformable model,” both of which are incorporated herein by reference.

### SUMMARY

The present invention provides methods and apparatus to process a data set, such as a medical data set for a patient, including segmentation and reconstruction to generate a patient endoluminal model in three dimensions. The generated model, including endoluminal surfaces, can be used for a variety of applications, such as for example, interventional radiology, endoscopic surgery, airway management, procedures interacting with endoluminal anatomical structures, catheter simulation, blood/air flow simulation, and virtual endoscopy. While the invention is primarily shown and described in conjunction with processing medical data, it is understood that the invention is applicable to a wide range of data sets having luminal structures, including tree modeling, engine pipe defect diagnose, and etc.

In one aspect of the invention, a method for generating a network of endoluminal surfaces comprises defining a set of medial axes for a tubular structure, defining a series of cross sections along medial axes, generating a connectivity graph of the medial axes, defining multiple surface representations based upon the graph of the medial axes and the cross sections, computing a volume representation defined by one of the surface representations, defining a partition of the medial axes, cross-sections, surface and volume representations, and outputting both these multiple representations and their partition of the network of endoluminal structures.

The method can include one or more of the following features: the surface representation includes convex and non-convex sets, deriving the endoluminal surface from a medical data set. The medical data set is selected from the group consisting of Computer Tomography Angiography (CTA), a Magnetic Resonance Angiography (MRA), CT scan, MRI, and a series of X-ray images, deriving the endoluminal surface by: enhancing contours of the endoluminal structure with anisotropic diffusion, cleaning the medical data set with masks and morphological operators for dilation and/or erosion to remove bones, artifacts, sinuses and/or skin, performing segmentation of the endoluminal structure through a level set evolution, performing skeletonization to obtain centerlines of the endoluminal structure, performing enhancements of the centerlines, performing cross-sectional ellipse estimation, and performing cross section post processing, performing skeletonization to generate the set of centerlines, which represent the medical data set as a set of three-dimensional lines marking the center of the endoluminal structure, performing enhancements of the centerlines by pruning, automatic line connections, and/or smoothing, the ellipse estimation is used to model endoluminal structure cross sections as simple cylindrical structures or ellipsoidal structures, using the ellipse estimation information to re-center the centerlines at each step, using the centerline and the ellipse data to creates the three-dimensional surface to approximate a boundary of the endoluminal structure by constraining bifurcations, tiling the surface of each endoluminal structures, tiling a junction between the surfaces, and recursively smoothing the surface, extrapolating missing ellipse values using flow computation, constructing a unified directed graph for multiple hollow lumen structures, using branching angle and vessel ellipses to reduce artifacts where representing the tubular structures, joining and/or merging the surface of a branch to another based upon a filet created by end-segment-grouping technique and/or adjacent-quadrant-grouping technique, adaptive cross sections distribution using ellipse profile and medial axis curvature profile of a vessel, eliminating incorrect bifurcations/junctions and/or reducing a bottle-neck effect and/or eliminating twisting artifacts, shrinking and then expanding the ellipse data set if a ratio between parent ellipse and child parent ellipse is greater than a selected value, generating generic or patient specific anatomical endoluminal structure representation, optimizing the surface for smooth visualization and for contact of the surgical instruments with the internal part of the endoluminal structure, adapting the surface complexity and smoothness by increasing the number of triangles composing the surface, generating the structured endoluminal model with multiple representations of lumen structures including polygonal surface, subdivision surface representation, implicit surface, medial axis representation, efficient and structured collision detection representation, volumetric representation, and abstract sampling point graph, generating information for display to a user from computation and deformation of the tubular structure, and using the endoluminal surfaces for one or more of interventional radiology, endoscopic surgery, airway management, procedures interacting with endoluminal anatomical structures, catheter simulation, blood/air flow simulation, and virtual endoscopy.

In another aspect of the invention, a method comprises receiving a data set having a luminal structure, segmenting the data set by: filtering the data set, performing skeletonization of the filtered data set, determining endoluminal centerlines from the skeletonized data set to form a structure, estimating ellipses for the structure, and outputting the structure with estimated ellipses. The method can further include refining the skeletonization of the structure from the estimated ellipses.

### BRIEF DESCRIPTION OF THE DRAWINGS

The foregoing features of this invention, as well as the invention itself, may be more fully understood from the following description of the drawings in which:

FIG. 1 is a block diagram of a system for processing a data set to generate a three-dimensional endoluminal model in accordance with an exemplary embodiment of the invention;

FIG. 2 is a flow diagram showing an exemplary sequence of steps to implement segmentation and reconstruction of a data set in accordance with an exemplary embodiment of the invention;

FIG. 3 is a pictorial representation of exemplary cross-section post processing;

FIG. 4A is a pictorial representation of prior art cross section processing for a circle;

FIG. 4B is a pictorial representation of a cross section processing for an ellipse;

FIG. 5 is a pictorial representation of trunk branch selection;

FIGS. 6a-b are pictorial representations of cross section distribution;

FIGS. 7a-b are pictorial representations of connecting segments;

FIG. 8a-b are pictorial representations of adjacent quadrant grouping;

FIG. 9a is a pictorial representation of a silicon phantom with nylon tubing to mimic a vascular structure;

FIG. 9b is an image of a CTA where the tubing of FIG. 9a is filled with contrast agent;

FIG. 9c is a skeletonization of the image of FIG. 9b after pruning and smoothing;

FIG. 9d is a display of reconstruction of the three dimensional surface;

FIG. 10a is reconstructed vascular surface along with a fluoroscopic view of a patient skull;

FIG. 10b is a zoomed in view of a bifurcation surface from the image of FIG. 10a;

FIG. 11a is a coronal view of a reconstructed vascular surface for an arterial side;

FIG. 11b is a coronal view of a reconstructed vascular surface for a venous side;

FIG. 11c is a coronal view of a reconstructed vascular surface showing the arterial side of FIG. 11a and the venous side of FIG. 11b;

FIG. 12a is a sagittal view of a reconstructed vascular surface for an arterial side;

FIG. 12b is a sagittal view of a reconstructed vascular surface for a venous side;

FIG. 12c is a sagittal view of a reconstructed surface showing the arterial side of FIG. 12a and the venous side of FIG. 12b;

FIG. 13a is a coronal view of a reconstructed arterial surface generated from MRA data;

FIG. 13b is a sagittal view of the reconstructed arterial surface of FIG. 13a;

FIG. 14a is a coronal view of reconstructed coronaries; and

FIG. 14b is a sagittal view of reconstructed coronaries.

### DETAILED DESCRIPTION

The present invention provides methods and apparatus to segment and extract luminal structures, including but not limited to vascular systems, abdominal organs (gastrointestinal, biliary, urinary), and/or airways/bronchi from medical imaging data sets. The generated sections can then be integrated into a three-dimensional computer model allowing real time and optimal visualization and computation. International patent application PCT/US2005/028594, filed on Aug. 10, 2005, entitled “Methods And Apparatus For Simulation Of Endovascular And Endoluminal Procedures,” which is incorporated herein by reference, discloses an exemplary simulation application that can utilize 3D endoluminal models generated in accordance with exemplary embodiments of the present invention.

In one embodiment, adaptivity/scalability of the reconstructed geometrical model enables a trade-off between accuracy and efficient computation. It is understood that the term adaptivity refers to (1) more triangles can be generated if a more accurate surface is needed, (2) less triangles can be generated for a computationally efficient model (for visualization, surgical instrument interactions, etc.), or for fast deformation simulation. Given the accuracy of the exemplary embodiments, relatively small vessels can be modeled therefore giving the possibility to apply it to peripheral vessels. Other hollow organs such as the bronchial tree or intestinal and urinary structures can also be generated.

Such models can be used in a variety of medical applications including interventional radiology, endoscopic surgery, and airway management to name a few. For example, in neuro-vascular intervention, a three-dimensional surface of patient vasculature can be used to detect and quantify the pathological conditions, like stenosis or aneurysm. Objectives for these applications could be surgical education and training within a simulated environment, surgical planning or rehearsal, augmenting operating room systems to assist in navigation, imaging or detection, new device prototyping, and just-in-time guidance systems.

As described in detail below, exemplary embodiments of the invention provide a streamlined semi-automatic process generating a computer model that is accurate within set threshold levels, has smooth and continuous properties, indexed through a common structure, consistent in its organization, and can be manipulated efficiently in real-time. To generate a model, the inventive embodiments can utilize a combination of a segmentation algorithm and a surface reconstruction technique described in detail below.

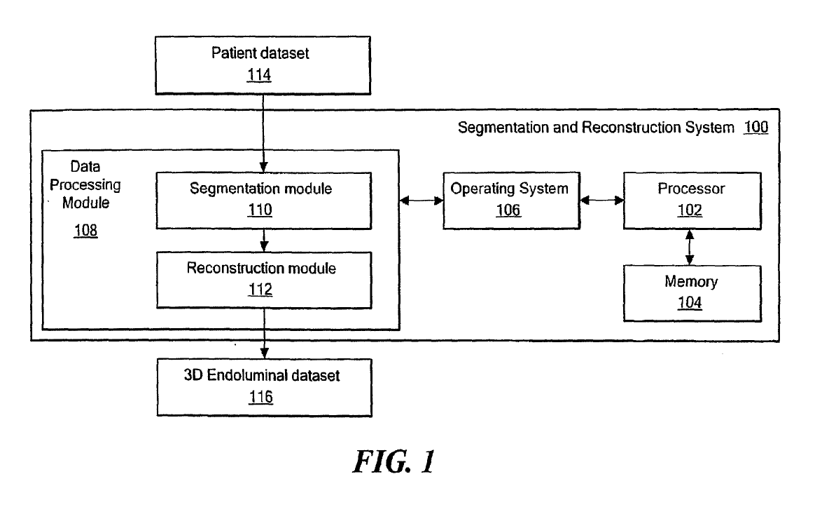

FIG. 1 shows an exemplary system 100 for segmentation and reconstruction of luminal structures in accordance with exemplary embodiments of the invention. The system 100 includes a processor 102 supported by memory 104 to run under a computer operating system 106 in a manner well known to one of ordinary skill in the art.

In an exemplary embodiment, the system 100 includes a data processing module 108 that can include a segmentation module 110 and a reconstruction module 112. As described in detail below, the data processing module 108 receives a data set 114 for segmentation by the segmentation module 110 and reconstruction by the reconstruction module 112 to provide data to a 3D endoluminal model module 116 that can generate a 3D module for use by a simulator or other application.

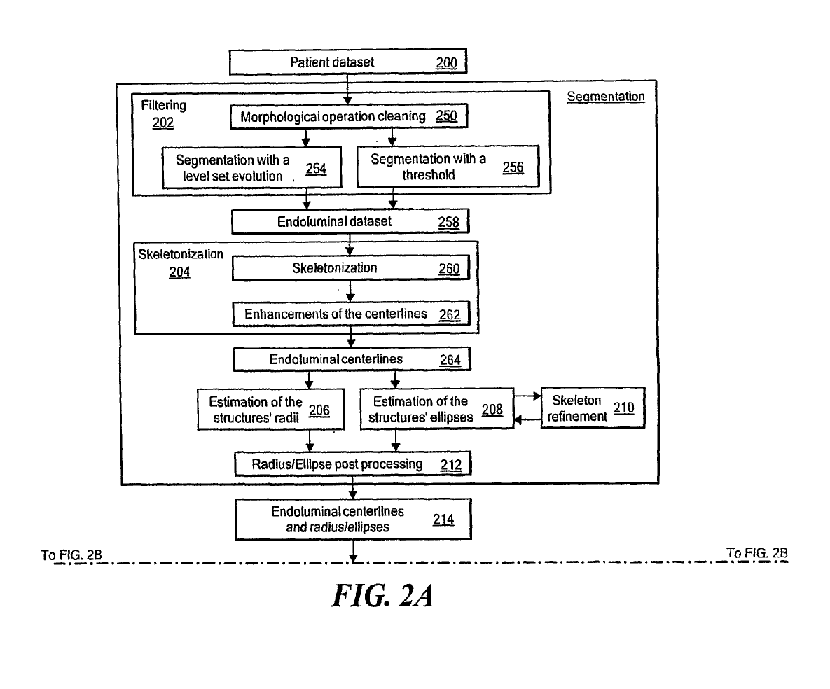

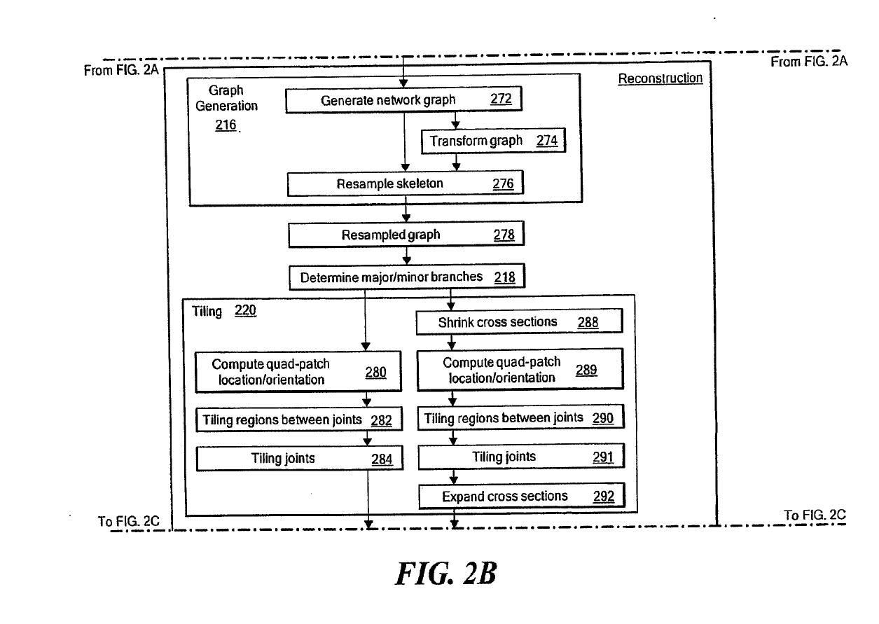

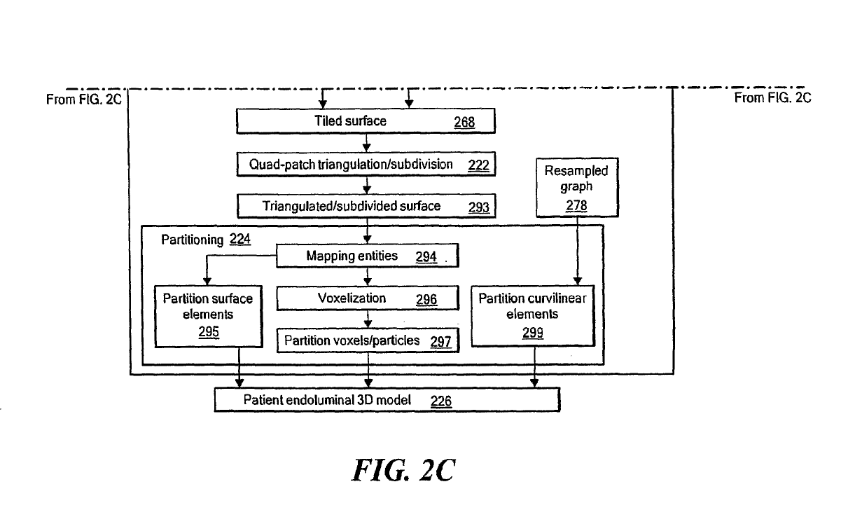

FIG. 2 shows an exemplary sequence of steps for segmentation and reconstruction of a patient dataset. In step 200, a patient dataset is received and in step 202 the dataset is filtered. In step 204, skeletonization is performed from which an estimation of structure radii is provided in step 206 and/or an estimation of structure ellipses is provided in step 208. Based upon the estimated structure ellipses, in step 210 the skeleton can be refined. In step 212, radius/ellipse post processing is performed. Steps 202-212 correspond to the segmentation process.

After segmentation, in step 214 endoluminal centerlines are defined based upon the segmentation process.

In step 216, the reconstruction process begins by generating graphs based −upon the segmentation process. In step 218, major and/or minor branches are defined after which tiling is performed to generate surfaces in step 220. In step 222, quad-patch triangular subdivision is performed and partitioned in step 224. Steps 216-224 correspond to the reconstruction process.

After reconstruction, in step 226, a patient endoluminal 3D model is generated.

Further details of the filtering step 202 of FIG. 2 are set forth below. In step 200, a patient dataset is received from an imaging system, such as commercial medical scanner, e.g., Computed Tomography Angiography (CTA) or Magnetic Resonance Angiography (MRA). In step 202, the image is filtered including in step 250 morphological cleaning. In an exemplary embodiment, an anisotropic filter (see e.g., Krissian, K., 2002. Flux-based anisotropic diffusion applied to enhancement of 3-D angiogram. IEEE Trans Med Imaging, 21, 1440-2) is used to reduce the data noise while retaining small structures therefore improving their detection. For example, for a neuro-interventional vascular application, a majority of brain's vessels with radii smaller than 2.0 mm need to be captured by the segmentation. The parameters of the segmentation are the standard deviation of the filter, the attachment coefficient, and the local pixel neighborhood. This nonlinear filter allows the intensity of the borders to be increased while lowering the noise intensity value simultaneously. Extraneous objects with similar intensities compared to the target structure should be removed using morphological operations (dilation and erosion). For example with the neuro-vascular application, the skull, the sinuses, and the skin, can have intensities relatively close to the targeted vascular network. In most cases, the process is based, on the application of a mask on the image that is computed through several dilations in order to fill the small cavities in the desired anatomical structure. A larger number of erosion iterations is then applied to finalize the mask. Multiplying the dataset by this mask allows erasing the structures that are not kept (skin, sinuses in the brain application). In every type of applications, the bones are removed via the same path: segmentation through a regular thresholding followed by the application of a mask (additional steps of erosion) to remove the transition part between extraneous elements such as bones and the targeted structure. Indeed, this transition has an intensity value close to the endoluminal structures which could be confusing for the detection of the structure studied especially due to their proximity in some locations.

In one embodiment, in step 254 the segmentation of the structure contours is accomplished by the means of a level set evolution (see Osher, S., Sethian, J. A., 1988. Fronts propagating with curvature dependent speed: algorithms based on the Hamilton-Jacobi formalism J. Comput. Physics, 79, 12-49, and Sethian, J. A., 1999. Level Set Methods and Fast Marching Methods: Evolving Interfaces in Comp. Geom., Fluid Mech., Comp. Vision and Materials Sci. Cambridge Univ. Press) applied on the enhanced data set. The initialization of the active contour is performed using a threshold on the image intensity for better efficiency. Indeed, manual selection of seed points would be time consuming and less robust since some parts could be disconnected and therefore missing. Instead of, or in addition to a level set, in step 256 a straightforward threshold can be applied to segment the dataset. Although the level set technique is more expensive computationally, it allows a better estimation of the contours based on both intensity values and edges. In step 258, the resulting endoluminal dataset is stored for further processing.

In an exemplary embodiment, the level set equation evolves a surface according to three different forces: an advection force that pushes the surface towards the edges of the image; a smoothing term, proportional to the minimal curvature of the surface (see e.g., Lorigo, L. M., Faugeras, O. D., Grimson, W. E. L., Keriven, R., Kikinis, R., Nabavi, A., Westin, C.-F., 2001. CURVES: Curve Evolution for Vessel Segm. MedIA, 5, 195-206), that keeps the surface smooth; a balloon force that allows the contours to expand within the endoluminal structures. These forces rely on the intensity statistics to either expand or shrink the evolving contour. The parameters of the segmentation are: the intensity, the mean intensity of the studied structure, their standard deviation, and the threshold allowing shrinking the contour when the position is unlikely to belong to the structure.

From the images segmented by the level set, in step 260 skeletonization (step 204 FIG. 2) is applied to obtain the endoluminal structure's centerlines. This process allows a simulator to efficiently perform collision detection and blood flow computation by supplying an abstract topological representation of the endoluminal network. It is based on homotopic thinning where voxels are removed in the order of the Euclidean distance to the segmented surface. Voxels are iteratively removed from the object if they are simple (see e.g., Malandain, G., Bertrand, G., Ayache, N., 1993. Topological Segmentation of Discrete Surfaces IJCV, 10, 183-197) and if they are not end-points, such that they have more than one neighbor in a 3×3×3 neighborhood.

The skeletonization process in step 260 leads to a set of rough centerlines that can still have connectivity discrepancies especially near small branches. In step 262 the centerline positions are enhanced as pruning is applied to remove small leaves (lines connected at only one extremity or line with no connection) from the centerline tree. Given the resolution of the medical data set, some lines remain disconnected when they should be part of the same endoluminal structure. They are connected by using a semi-automatic process that selects close lines with a corresponding direction. The direction criterion helps to match lines within a small curvature difference. This step often requires manual adjustment since some lines might be too long to be deleted by pruning or too distant to be connected automatically. Thus, this work consists of deleting or connecting the appropriate lines and completing the skeleton.

The manual step in the streamlined reconstruction is mainly due to a connectivity problem, driven by “holes” in the studied structures. Those holes are discontinuities produced by artifacts, such as the metal in dental repairs, or by low resolution in the data that makes small structures look like dashed lines. This manual interaction is not necessary in good data sets, e.g. higher resolution with endoluminal structures clearly separated with the rest and with each other. Depending on the level of details expected for the small parts, the manual task may take a relatively long time for large data sets with noisy images, such as the brain.

In general, the amount of manual work can be reduced by improving the detected centerlines via re-orienting the lines and separating tangent endoluminal structures, which are currently merged under the imaging resolution. The other manual step aims to detect small endoluminal structures. Both tasks will benefit from an a priori knowledge based on an anatomical atlas or template.

Once the endoluminal structures are finally connected, a conventional technique is then to estimate the radii of the centerlines in step 264. They are extracted to describe the circular surface of the endoluminal structures. This process is based on a known algorithm growing a circle in the orthogonal plane of the centerline points. It computes, along circles of increasing radii, the intensity gradient, i.e. the derivatives of a Gaussian kernel with a given standard deviation, in the medical data set. It stops when a relevant local maximum of the intensity gradient is found on the cross-section therefore estimating the radii along the centerlines.

In one aspect of the invention, the system includes fitting all ellipse instead of a circle to estimate the cross sections. The ellipse fitting technique better matches, as compared with circles, actual endoluminal structure geometry without sacrificing the smoothness and the low complexity of the mesh. Based on initial estimated centerlines and a segmentation of the endoluminal network, ellipses are fitted in the planes of the endoluminal cross-sections, defined as the planes orthogonal to the centerlines. The ellipses are fitted at points regularly distributed along each centerline. The fitting procedure uses a mean least square error described in (see e.g., Fitzgibbon A., Pilu M. and Fisher R. B., 1999. Direct Least Square Fitting of Ellipses. IEEE PAMI, vol 21, no 5) based on the points extracted from an interpolated contour of the current segmented cross-section.

The ellipse-fitting problem is described as follows: from a set of points in a plane (xᵢ, yᵢ)_{ic [1,N]}, find the ellipse that minimizes the mean square error. The general conic is described as:

F(a,x)=a·x=0,

where a=[a b c d e f]^{T} and x=[x² xy y² x y]^{T}. F is called the “algebraic” distance of a point (x, y) to the conic F(a, x)=0, and the fitting is posed as a minimization of Σ^{N}ᵢ₌₁ F(a, xᵢ)², with xᵢ=[xᵢ² xᵢ yᵢ yᵢ² xᵢ yᵢ]^{T}.

The solution is constrained to be an ellipse by imposing b²−4ac to be negative, which, through a scaling of the parameters, can also be written as 4ac−b²=1, or a^{T}Ca=1,

$$with C = [ \begin{matrix}… & … & 2 & … & … \\ … & - 1 & … & … & … \\ 2 & … & … & … & … \\ … & … & … & … & … \\ … & … & … & … & …\end{matrix} ] ,$$

where . means 0. The problem is thus written as a minimization of ∥Da∥², subject to a^{T}Ca=1, where D is the N×6 matrix [x₁ . . . x_{N}]^{T}. Introducing the Lagrange multiplier λ, the problem is written as:

Sa=λCa

a^{T}Ca=1.

The system is solved by considering the generalized eigenvectors of Sa=λCa. And the eigen-vector can be scaled to satisfy a^{T}Ca=1. If S is positive definite, which is generally the case, the system gives rise to only one positive eigenvalue, which corresponding eigenvector is the solution, giving the ellipse parameters, i.e., center, main axis directions and lengths.

An iterative scheme allows improving both the fitted ellipses and the sub-voxel location of the centerlines by updating the position of the centerline based oil the center of the fitted ellipses and iterating. Two iterations are experimentally sufficient to reach near convergence (displacements of the centerlines by less than 0.1 mm). As a consequence, the elliptical cross section estimation provides an enhanced fitting of the skeleton in the center of the endoluminal structures, and a better fitting of their surfaces and junctions. The combination of the centerlines and the elliptical estimation allows a very accurate representation of the endoluminal structures and therefore a good surface reconstruction.

In an exemplary embodiment, the two fitting (conventional circular and novel ellipse) techniques are both available in to the segmentation process to enable the user to decide which level of details is needed.

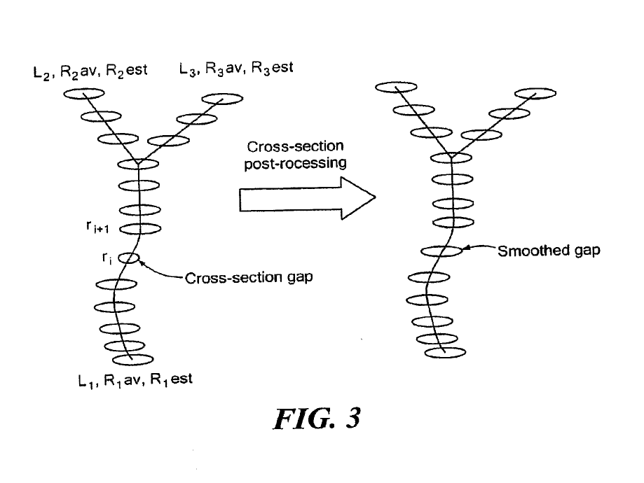

Referring again to step 212 in FIG. 2, once the cross sections are estimated along the centerlines, post processing is applied to the radius/ellipse data. It allows filling the possible gaps in the estimation, due to a low resolution data set, artifacts, or errors when two or more endoluminal structures are touching each other, as shown in FIG. 3. The inventive post processing method enhances the cross section estimation and guarantees a smoother surface, close to the segmented one. It is based on a computation of the average radius/ellipse Rᵢav of the current centerline Lᵢ and then an estimation of the cross section too far from this average value (within the range of a 40% variation). If this is the case, the so-called gap rᵢ is replaced by the mean value Rᵢav. To know if the centerline average radius/ellipse Rᵢav is correct, a flow estimation is derived from the source of the graph. This estimation is based on a cubic conservation of the flow. For example, at a bifurcation, the cube of the radius of the two children must be equal to the cube of the radius of the parent endoluminal structure. For example in FIG. 3: (R₁est)³=(R₂est)³+(R₃est)³. By comparing this estimated flow value Rᵢest, one can determine if the current average radius/ellipse value Rᵢav is within the flow conservation range. If it is not the case, it is replaced by Rᵢest. FIG. 3 shows post processing of the cross-sections where for every centerline Lᵢ, each gap and each consequent geometrical variation of the radius rᵢ are smoothed out based on comparisons with the average radius Rᵢav and the estimated radius Rᵢest.

The post processing process can be summarized for each centerline as set forth below:

If R₁est − 40% < R₁av < R₁est + 40%

Then if R₁av − 40% < rᵢ < R₁av + 40%

Then keep rᵢ
Else rᵢ = R₁av

Else rᵢ = R₁est

Use of the inventive post processing ensures a smooth and complete surface. Though it may create parts of the endoluminal structure cross sections based on close-by cross sections, and therefore approximate the missing ones, it avoids possible gaps and strong geometrical changes of the surface.

### Surface Reconstruction

Following the skeletonization and the radius or ellipse estimation, the surface reconstruction method generates a smooth surface that can be readily refined to suit the needs of efficient collision detection and collision response, stable endoluminal structure deformation, real-time flow simulation, and multi-scale anatomical visualization. In one embodiment, the technique reconstructs quadrilateral surface patches of branching tubular structure.

Additional details of the graph generation process 216 of FIG. 2 are set forth below. From the endoluminal centerlines and radii/ellipse data in step 270, a network graph is generated in step 272. The graph is transformed in step 274, as described below, to enable resampling of the skeleton in step 276 from the original network graph (step 272) and transformed network graph (step 274). The graph is then resampled in step 278.

The mesh generator presumes the input in the form of the endoluminal structure centerline tree. In one embodiment, the tree has the following structure: the tree nodes are located in the branching points and in the end points. Each node stores the incoming segment as a list of centerline vertices lying on the path from the previous node to this node. The centerline vertices are stored with one radius value (for circular cross sections) or two radii (for elliptic cross sections) of the endoluminal structure. Each pair of subsequent vertices forms a segment section. The branching tree-segments are represented by links to the successive (children) nodes.

The inventive algorithm uses generalized cylinders with either circular or elliptic end cross sections along the segments and constructs a transition surface at the joints. The algorithm can solve n-furcations (n-times branching) and constructs a single, topologically correct 2-manifold mesh. The presented approach handles multiple branching in a unified way.

The base mesh generation is done recursively from the reference branch. Each branch is discretized into segments. Each segment has two circular or elliptic end cross-sections and a line segment connects the two.

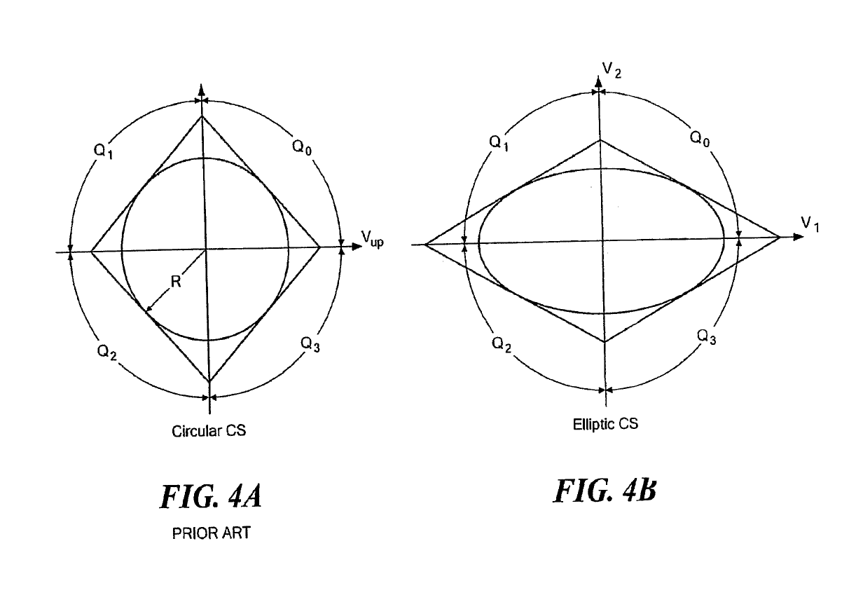

As shown in FIG. 4, in the base mesh, circular cross sections are approximated by described squares. Elliptic cross sections are approximated by described diamond polygon. Subsequent subdivision of the square or the diamond converges to a circle or ellipse. The procedure then patches segments in the bifurcation regions, and the area between two end segments of the surface.

The procedure includes three tasks:
Tile the surface from the second segment to the one preceding the last segment by assuming the first segment has been tiled in previous call;
Tile the joint by patching the end segment of the surface and the beginning segments of other branches that share this joint;
Finish by recursive calls of itself to the parent and children branches of the reference branch.

Further details of the tiling step 220 of FIG. 2 are now described. In step 280, in a first path, computations are performed for quad-patch location/orientation. In step 282, regions between joints are tiled and in step 284, tiling of the joints is performed to generate a tiled surface in step 286. In a second path, which includes shrinking and expanding, in step 288 cross sections for the structure are made to shrink. In step 289, the system computes quad-patch location/orientation. In steps 290 and 291, tiling regions between joints, and tiling of joints, respectively is performed. In step 292, the cross sections are expanded for tiled surface generation in step 286.

Further details for the partitioning step 224 of FIG. 2, include in step 293, a triangulated/subdivided surface is provided to mapping entities step 294. In a first path, voxelization is performed in step 296 and the voxels/particles are partitioned in step 297 for input to the patent endoluminal 3D model generation in step 226. Surface elements are partitioned in step 295 to provide input for the 3D model. From the resampled graph of step 298, curvilinear elements are partitioned in step 299.

In addition to the inventive combination of skeletonization and surface reconstruction, a further aspect of the invention comprises an improvement of (see e.g., Felkel, P., Wegenkittl, R., Bühler, K., 2004. Surface Models of Tube Trees. In: Computer Graphics International (CGI'04), pp. 70-77) in the first three of the four reconstruction sub-problems, decomposed by (see e.g., Meyers D., Skinner S., Sloan K.: Surfaces from contours. ACM Trans. Graph. 11, 3) as following:
The correspondence problem is solved by filtering the raw skeletonization result and distributing cross sections according to its geometric profile, i.e. radius and curvature;
The tiling problem is handled intrinsically by the skeletonization and preserved by the above filtering, since cross sections are centered and ordered on the centerline;
The branching problem is resolved by a recursive patching scheme to connect the patches of branching endoluminal structures to that of the trunk endoluminal structures regardless of endoluminal structure orientations;
The surface-fitting problem is answered by a Catmull-Clark or Loop subdivision algorithm (see e.g., Biermann H., Levin A., and Zorin D., 2000. Piecewise smooth subdivision surfaces with normal control, SIGGRAPH, pages 113-20, New Orleans, La., USA) on the base mesh.

The exemplary embodiments handle more generic directed graph structure where one branch is allowed to have multiple parents as well as multiple children. One branch can also connect to another single branch forming 1-furcation or mono-furcation. Since in human beings artery vessels can form loops, e.g. the cerebral arterial circle-Circle of Willis, vessel looping is also allowed. This is useful to construct a unified directed graph for both arterial and venous sides. Also, multiple trees can be reconstructed at the same time.

The base mesh of the vascular surface is constructed by connecting adjacent cross section's circumventing quadrilaterals (4-sided polygons). The 4-sided equilateral circumventing a circle is a square, whereas the polygon of an ellipse is a diamond. Since a circle is homogeneous around its center, the orientation and the rotation of the circumventing square can be arbitrary. Connecting two parallel but arbitrarily rotated squares could result unwanted twisted surface. In order to form the base mesh of an endoluminal network without introducing artificial twist, the rotation of each circumventing square needs to be determined rather than arbitrary. The determination of each square's rotation is achieved by a process, called up-vector propagation. The four corner points of a square and its center are used to form four ordered vectors, namely v_{0 . . . 3}. The first vector v₀ is called the up-vector \vec{up} of this square, shown in FIG. 4. Four quadrants, Q₀ to Q₃, are then ordered accordingly. The up-vector of the first cross section of a root branch, say \vec{up}₀, who has no other branches connecting at its beginning, is chosen arbitrarily. Then the up-vector of the second cross section, say \vec{up}₁, is determined by project \vec{up}₀ onto the plane where the second cross section resides. The process continues for subsequent cross sections of each root branch until it reaches the end of a branch.

When a branch joint has multiple parents, the end cross section's \vec{up}ᵢⁱⁿ of each parent branch Bᵢⁱⁿ is projected onto the plane defined by the joint location and a child centerline Bⱼ^{out} first normal as \vec{up}_{i,j}^{out} by a minimal rotation from one parent's end normal nᵢⁱⁿ to one child's beginning normal nⱼ^{out}. Then these projected \vec{up} are averaged. If the averaged vector is close to singular, then an arbitrary unit length vector v perpendicular to nⱼ^{out} is chosen as \vec{up}ⱼ^{out}. The Up vector propagation is summarized in Equation 2.

$${{up}^{}}_{j}^{out} = \{ \begin{matrix}\frac{{\sum }_{i} {{up}^{}}_{i , j}^{out}}{\vert {\sum }_{i} {{up}^{}}_{i , j}^{out} \vert} & \vert {\sum }_{i} {{up}^{}}_{i , j}^{out} \vert > ɛ \\ v & v ⊥ {n}_{j}^{out} \vert {\sum }_{i} {{up}^{}}_{i , j}^{out} \vert \leq ɛ\end{matrix} \qquad ( 2 )$$

When model a cross section as an ellipse, the circumventing 4-sided equilateral polygon is a diamond. Notice a square is a special case of a diamond shaped polygon where all 4 inner corner angles are 90 degree. The orientation of each ellipse is determined by the skeleton data which provides three vectors to describe per ellipse, i.e. short axis, long axis, and the normal vector of the ellipse's plane. Thus the up-vector will be the positive long axis vector. There is no need to perform any more up-vector propagation in elliptic cross section case. The benefit is not only a simpler base mesh construction process, but more importantly preserve the intrinsic surface twist where circular cross sections could not capture.

To patch the surface at lumen network joints, both surface reconstruction algorithms first define two trunk branches, i.e. incoming and outgoing branches. Then it forms polygons to connect the trunk surface and other joint branches' base mesh. The previous approach classifies endoluminal structures into forward and backward branches. Only forward branches are used to compute the average forward normal, n_{avg}, to avoid singularity. The endoluminal structure i, whose starting normal nᵢ is the closest to n_{avg}, is labeled as the outgoing trunk branch. The centerline curve tangent nᵢ(x) at location x is approximated by differentiating adjacent sampling points.

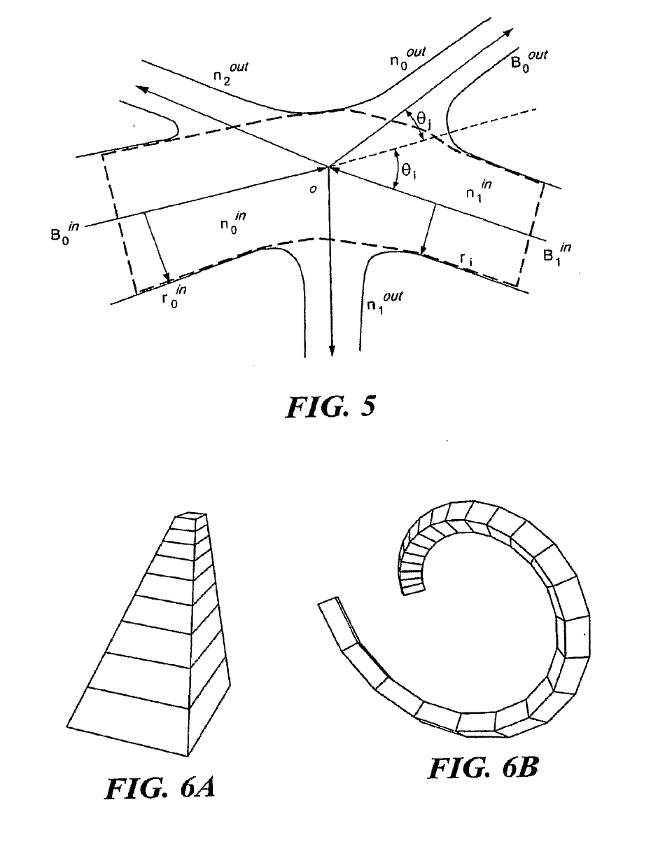

As illustrated in FIG. 5, when the sampling density is high, the approximated local tangents n₀ⁱⁿ and nᵢⁱⁿ(x) at the joint of B₀ⁱⁿ and B₁ⁱⁿ, respectively, will be similar to each other, or otherwise opposite in direction. When centerlines are under sampled, the approximated normals can be misleading. For example, in FIG. 5 trunk branch selection based only on branching angles chooses B₀^{out} as the trunk branch and thus introduces patching artifact. Trunk branch selection using both endoluminal structures' average radii and branching angle to determine the continuation trunk of current branch, B₀ⁱⁿ. Although θⱼ<θᵢ, the inventive algorithm chooses B₁ⁱⁿ as the trunk branch of B₀ⁱⁿ due to the similarity of their average radii.

The inventive trunk branch selection scheme is based on both branching angle and endoluminal structure radii to reduce under-sampling artifacts, because this improves the robustness and the smoothness of surface reconstruction. At a joint, there can be more than one incoming as well as multiple outgoing branches. Firstly nᵢⁱⁿ, (i>0) are reversed. Then, the disparity Ωᵢ is computed. It is defined in Equation 3 as:

Ωᵢ≡λθᵢ(1−λ)|rᵢ−rⁱⁿ₀| (3)

where λε[0,1] is the weight balancing the influence of the branching angle and that of the averaged endoluminal structure radius. λ=0.5 is used. The algorithm picks the branch with minimal Ω as the trunk branch. In FIG. 5, although θⱼ<θᵢ, formed by (n₀ⁱⁿ,−n₁ⁱⁿ), B₁ⁱⁿ is still chosen as the trunk continuation of B₀ⁱⁿ, due to the similarity of their average radii.

Each sampling point on a centerline curve is the center of the circular cross section. In a conventional approach, these sampling points are obtained from a down-sampling process from the segmentation result. Evenly distributed sampling vertices do not accurately reflect the endoluminal structure geometry, e.g. diameter, curvature. For instance, the right external carotid artery with average radius 1.7 mm will have the same density of sampling points as that of the left common carotid artery with radius 4.8 mm. This potentially causes regions with excessive surface patches and areas with insufficient patches to connect the endoluminal structure geometry.

In order to incorporate the geometry characteristics, the present invention adaptively distributes the sampling points according to both endoluminal structures' radii and centerline curvature profiles

$$\begin{matrix}{x}_{i + 1} - {x}_{i} = α ( \frac{{r}_{i + 1}}{1 + {βκ}_{i + 1}} + \frac{{r}_{i}}{1 + {βκ}_{i}} ) & i ∈ [ 0 , {N}_{segment} - 1 ]\end{matrix} \qquad ( 4 )$$

where xᵢ is the curvilinear coordinate of the cross section center along the centerline. rᵢ and κᵢ are the corresponding radius and Gaussian curvature, respectively, obtained by linear interpolation between the ends of a raw skeleton segment which embeds xᵢ. α>0 is the desired distribution scalar. κᵢ is estimated according to (see Calabi, E., Olver, P. J., Shakiban, C., Tannenbaum, A., Haker, S., 1998. Differential and Numerically Invariant Signature Curves Applied to Object Recognition. IJCV (26):107-35). β>0 is the weight of curvature influence on the distribution. Equation (4) states that after skeleton filtering, the centers of two adjacent cross sections are placed closer if the endoluminal structure is thin or has sharp turns. When a thick branch is straight, there is no need to place more cross sections than needed. This approach compromises the centerline smoothness and sharp feature preservation as shown in FIG. 6.

Assembling (4) for all i yields (N_{segment}−1) nonlinear algebraic equations with (N_{segment}−1) unknowns, since x₀ and x_{N} are set to be the curvilinear coordinates of the endoluminal structure end nodes. Multidimensional secant method: Broydn's method (see e.g., Press, W. H., Teukolsky, S. A., Vetterling, W. T., Flannery, B. P., 1992. Numerical Recipes in C, University Press, Cambridge) is used to solve for all xᵢ. If Broydn's method cannot give an answer within the prescribed number of iteration steps, the final iteration result is used as the answer due to the global convergence property of Broydn's method. As shown in FIG. 6, the left cross section distribution is denser at thinner regions of an endoluminal structure. Cross sections are farther apart as the endoluminal structure diameter increases. On the right, the distribution density is higher where an endoluminal structure turns or twists. Relatively few cross sections are placed where the centerline curve is flatter.

When the base polygon is always a tetragon as in all other surface patches, the recursive joint tiling algorithm generates only quadrangle tiles. The inventive algorithm differs significantly from previous methods by introducing two techniques: end-segment-grouping and adjacent-quadrant-grouping, using neighbor quadrilateral patches to form the base polygon before tiling joint patches. This improves the smoothness of the reconstructed endoluminal structure with less patching artifact while preserving branching symmetry.

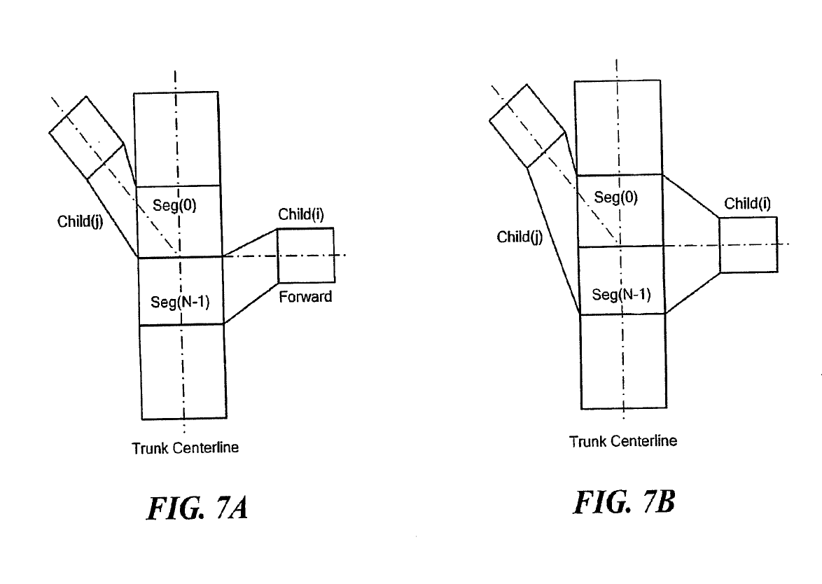

Instead of using different schemes to connect the main trunk with the backward branches or the forward branches, a single joint tiling scheme has been developed. We join branches and the main trunk in the same way regardless of the branching angles. Therefore a single recursive joint tiling process is needed for a branch joint. End-segment-grouping unifies all the outgoing branches together such that the connecting patches connect the bottom of the outgoing branch's base mesh with both end segments of the trunk branches, i.e. Seg(N−1) and Seg(0), demonstrated in the left of FIG. 7. As shown, depending on the outgoing endoluminal structure's orientation, Felkel's method, for example, connects Child(j) to Seg(0) and Child(i) to Seg(N−1). The inventive method connects Child(i) and Child(j) both Seg(N−1) and Seg(0). The bottle-neck effect is reduced and skeleton symmetry is preserved.

When the outgoing centerline forms a small angle with the trunk centerline, the previous approach produces a bottle-neck effect which can not be eliminated by surface subdivision. The bottle-neck effect is reduced when both end segments are deployed for the joint tiling. When the outgoing centerline lies near or close to the bisection plane of two trunk centerlines, using a single end segment cannot present the symmetry. The symmetry of this bisection situation is nicely preserved by connecting the base mesh of Child(i) with the side of both Seg(N−1) and Seg(0). End-segment-grouping not only reduces the patching artifacts in both extreme cases, but yields a smoother transition from the trunk to the branches under all branching angles.

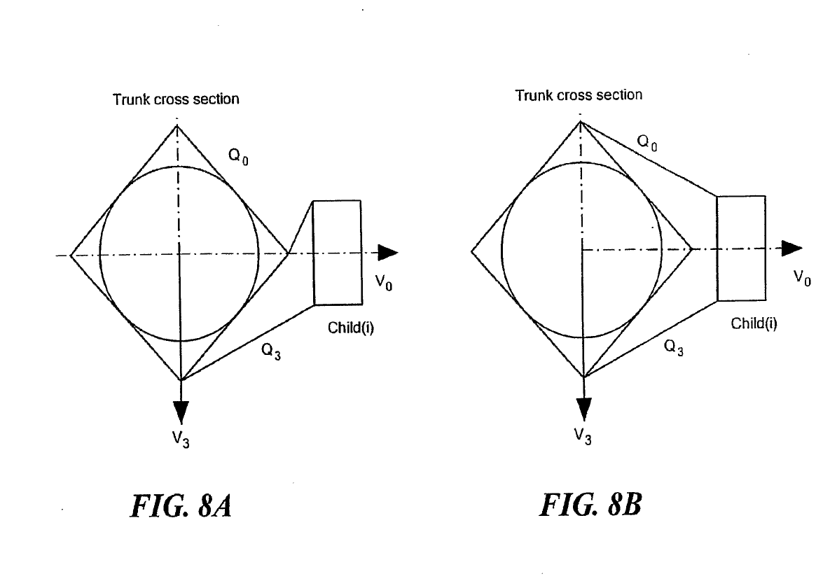

The bifurcation tiling is not only improved along the trunk centerline direction. Adjacent-quadrant-grouping is designed to use both adjacent sides of the end hexahedron segments. In FIG. 8, when a child centerline lies close to the boundary of a quadrant, e.g. Child(i) centerline lies in quadrant Q₃, but close to the boundary of Q₀ and Q₃, the former algorithm still uses only one quadrant, Q₃. The induced artifact is apparent. This situation is resolved in the inventive approach by adding the neighboring quadrant into the tiling. In this case, the adjacent Q₀ and Q₃ are grouped together as a whole when connecting with the base mesh of Child(i) to the trunk mesh. Grouping 2 adjacent quadrants is sufficient to preserve skeleton symmetry. When Child(i) centerline bisects a quadrant, the inventive approach uses only the current quadrant for the tiling. As shown in FIG. 8, Child(i) centerline lies close to the boundary of Q₀ and Q₃. Using only one quadrant Q₃ induces unwanted twisting artifact. Adjacent-quadrant-grouping uses both Q₀ and Q₃ to connect Child(i)'s base mesh to the trunk surface.

Because the joint tiling involves more than one trunk patch, the base polygon can have up to twelve edges. The recursive joint tiling algorithm examines the branching centerline's orientation and tiles a minimally twisted polygon surface. The pseudo-code of the recursive joint tiling is presented below.

Tile_Bifurcation(Base_Polygon, Segment, Branch)

Inverse Segment direction due to graph connectivity.

if (Segment intersects Base_Polygon)
if (Intersection close to the edge of Base_Polygon)
Base_Polygon=Expand(Base_Polygon);
//Form a new polygon without

//overlap edges.
Base_Polygon=Form_Polygon(Base_Polygon, Segment_Tetragon);
Branch=Current Segment's hosting branch.
Tile_Bifurcation(Base_Polygon, Next_Segment, Branch);
else //No intersection
if (None of the connected Segments intersects Base_Polygon)
Form_Min_Twisted_Patch(Base_Polygon, Segment_Tetragon);
Tile_Bifurcation(Base_Polygon, Next_Segment, Branch);

End

In some cases, with bifurcations going from a given radius to a much smaller radius, the reconstruction method adapts itself by first shrinking the cross sections before running the reconstruction tasks and then expanding the resulting surface patches. The large radius variations can cause misses when finding an intersection between a line segment and a triangle. The shrinking process reduces the size of circles or ellipses to the minimum radius/ellipse of the data set. The reconstruction is then unchanged with this constant radius/ellipse. Expansion allows recovering the original geometry of the endoluminal structure. This add-on of the reconstruction method guarantees a correct connectivity, especially at bifurcations of small and big endoluminal structures. The advantage is that it does not change the connectivity while creating a smooth surface.

Thus, the inventive reconstruction process is able to handle a more general directed graph. It is less prone to artifacts due to initial data sampling. It is also more robust to represent the full range of bifurcation configurations compared to existing work. The reconstructed smooth endoluminal surface is suitable for collision detection and collision response, flow computation and visualization.

### Applications

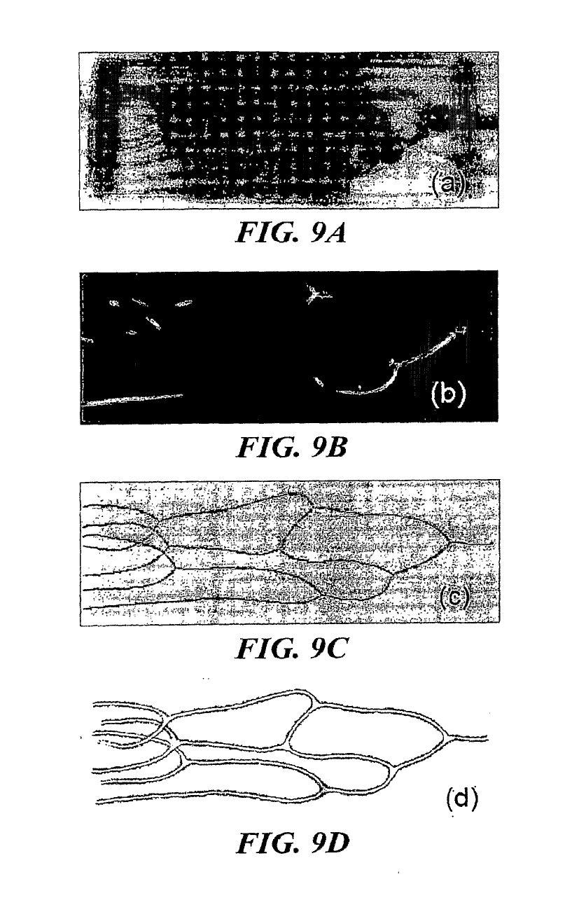

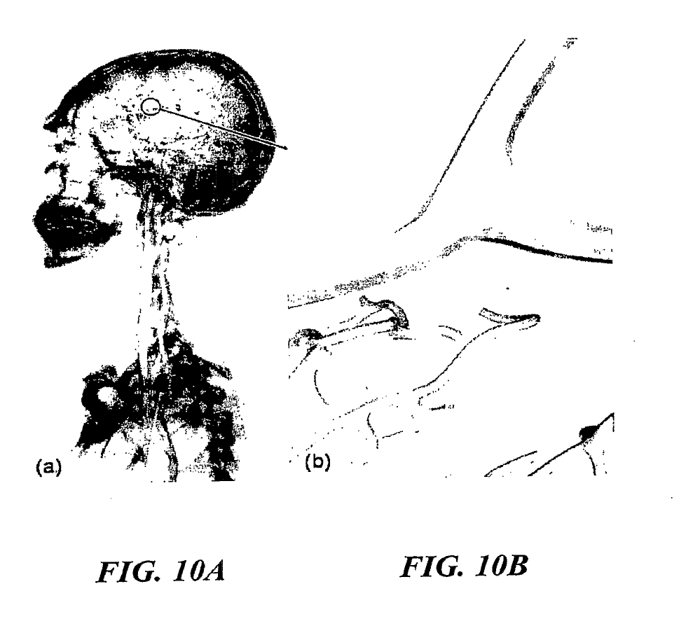

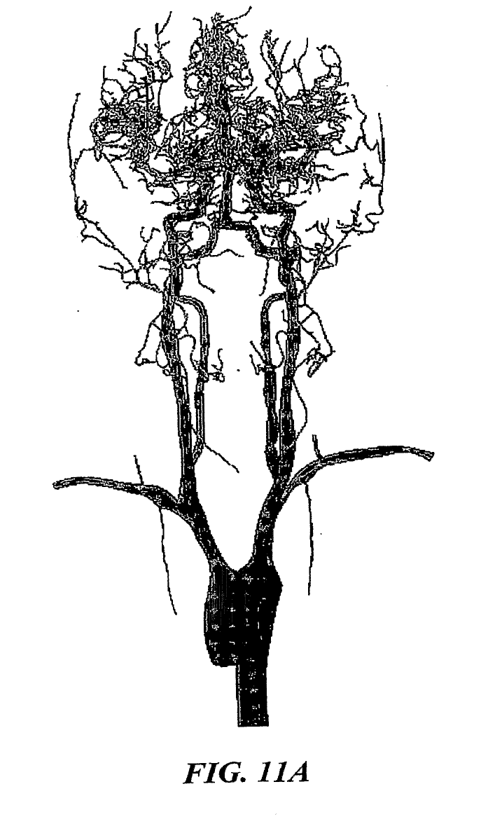

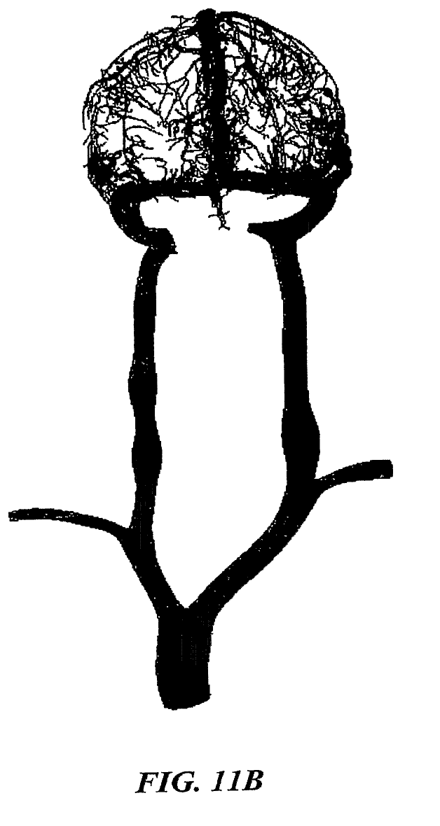

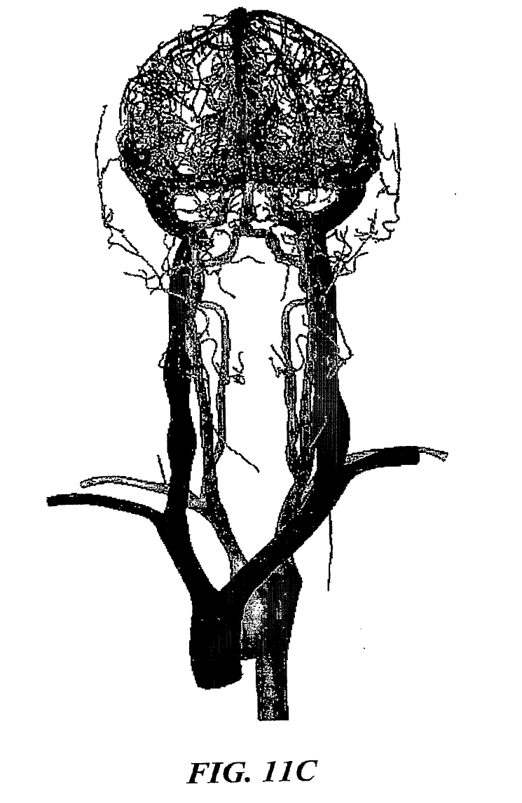

An exemplary embodiment of the invention was tested on a phantom FIGS. 9a-d, and on a head and neck vascular network in FIGS. 10 and 11. For this vascular application, a dense vascular network is obtained under the form of two sets of skeletons and radii. Their reconstruction leads to two models. One models arteries; from the aorta up to the small vessels in the brain when applied to neuro-interventional procedures (even the beginning regions of capillary arteries are segmented). The other model represents the veins, from the small veins in the brain to the vena cava.

In another aspect of the invention, a system can reconstruct a surface from one source and branches to finish with multiple leaves, which is the case for the arteries. Furthermore, the opposite is also true: from multiple sources, the system can converge to one leaf, as it is the case for the veins.

FIG. 9A shows a silicon phantom with nylon tubing mimicking a vascular structure, FIG. 9B an image of the CTA where the tubes are filled with contrast agent, FIG. 9C a result of the skeletonization after pruning and smoothing, and FIG. 9D a reconstruction of the 3D surface.

FIG. 10A shows a reconstructed vascular surface along with the fluoroscopic view of the same patient skull and FIG. 10B shows a zoom-in view on a bifurcation surface. FIGS. 11A-C shows a reconstructed vascular surface, first row: coronal view, second row: sagittal view. Each row is showing the arterial side, then the venous side, and both network to form the complete neurovascular network.

The present invention provides methods and apparatus to enable a streamlined process for segmenting and reconstructing a structured, smooth, robust, and efficient anatomical lumen network from a patient volume scan data. In exemplary embodiments, the invention consistently produces homogeneous skeletons and radii or ellipses. In one embodiment, the length variation stays within 0.6 times the length standard deviation, while the radius estimation is also accurate. Moreover, the root mean square of the Hausdorff distance between the reconstructed and the reference surfaces is always less than one voxel. The inventive reconstructed surface is efficient because the excellent fitting is achieved by using only 5% of iso-surface triangles. At the mean time, reconstructed surfaces are more than 10 times smoother than the reference (see Luboz V., Wu X., Krissian K., Westin C. F., Kikinis R., Cotin S., & Dawson S., 2005 A segmentation and reconstruction technique for 3D vascular structures. Proceedings of the MICCAI Conference, MICCAI 2005, pp 43-50, Palm Spring, Calif., October 2005).

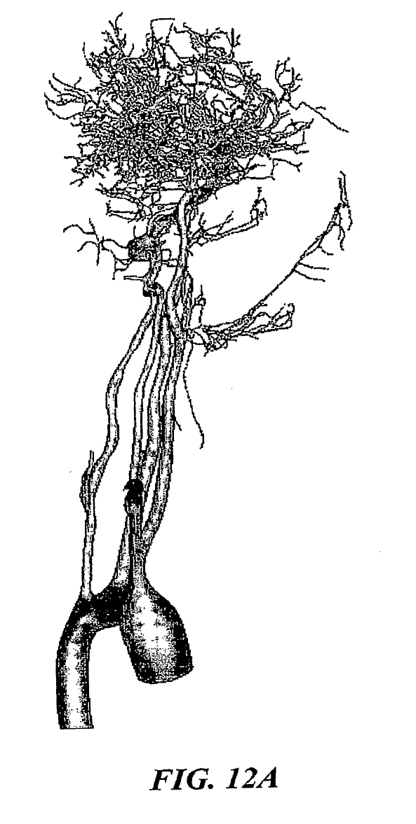

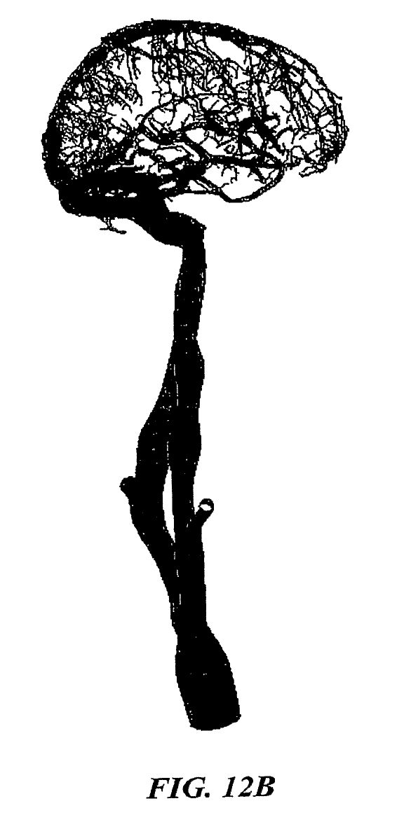

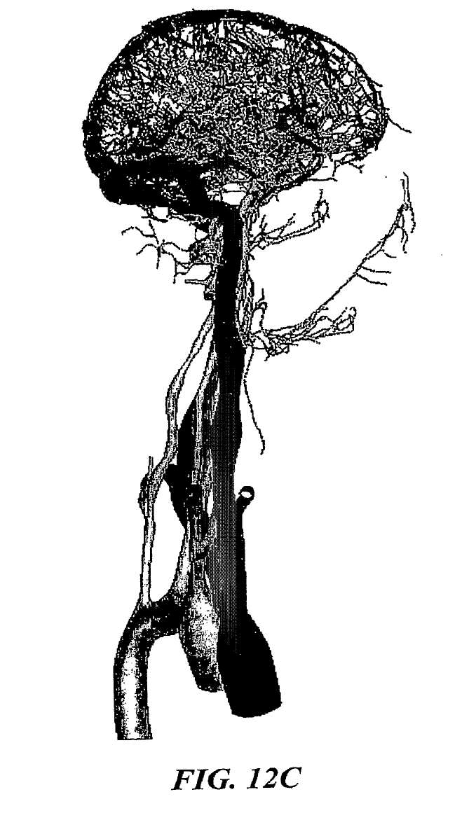

The level of detail reached in FIGS. 10 and 11 required manual involvements to connect the centerlines of the small vessels. These models are obtained from a CTA data set. The same algorithm has been applied to an MRA dataset in which the vessels are more conspicuous than in a CTA dataset, making segmentation easier. An hour of manual connection and cleaning of the centerlines leads to the model display in FIG. 12, which shows a reconstructed arterial surface: coronal and sagittal views, where the 3D model is generated from a MRA with minimal manual work.

This three-dimensional surface of the arteries would be enough for a surgeon to diagnose and plan an intervention. Indeed, the vessels (arteries up to Middle Cerebral Artery and Anterior Cerebral Artery's first segment) represented here are the ones in which the clinicians currently perform most of their interventions.

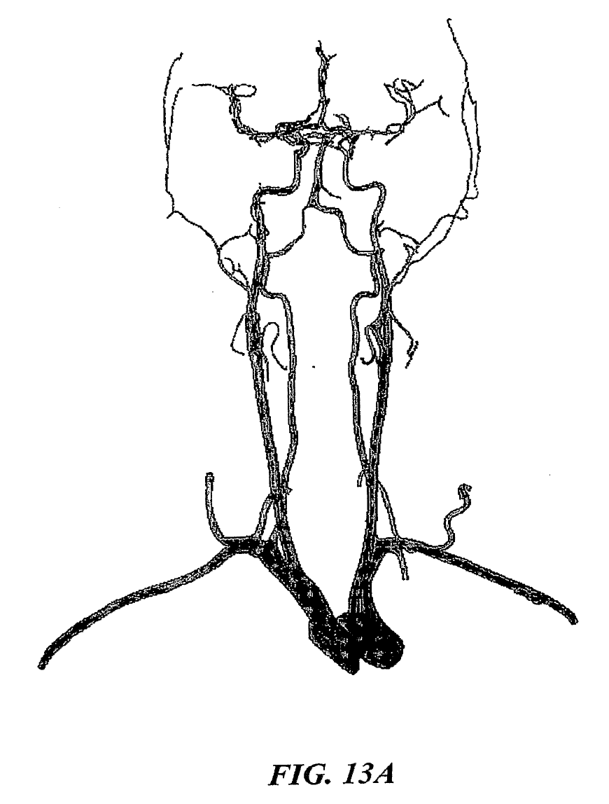

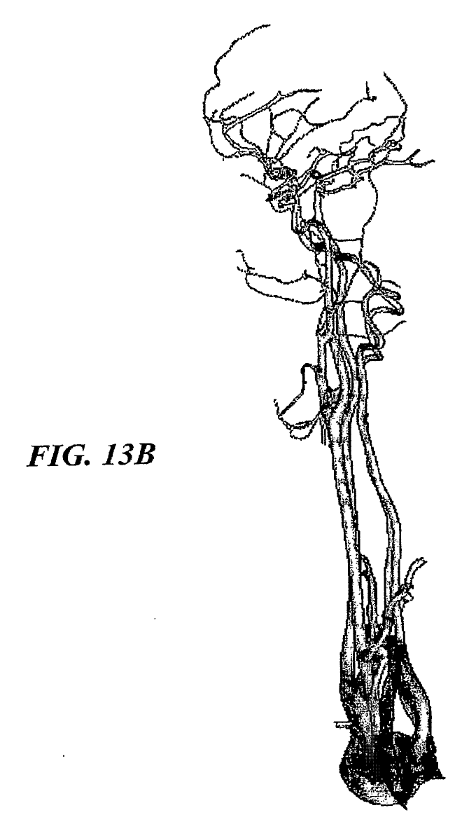

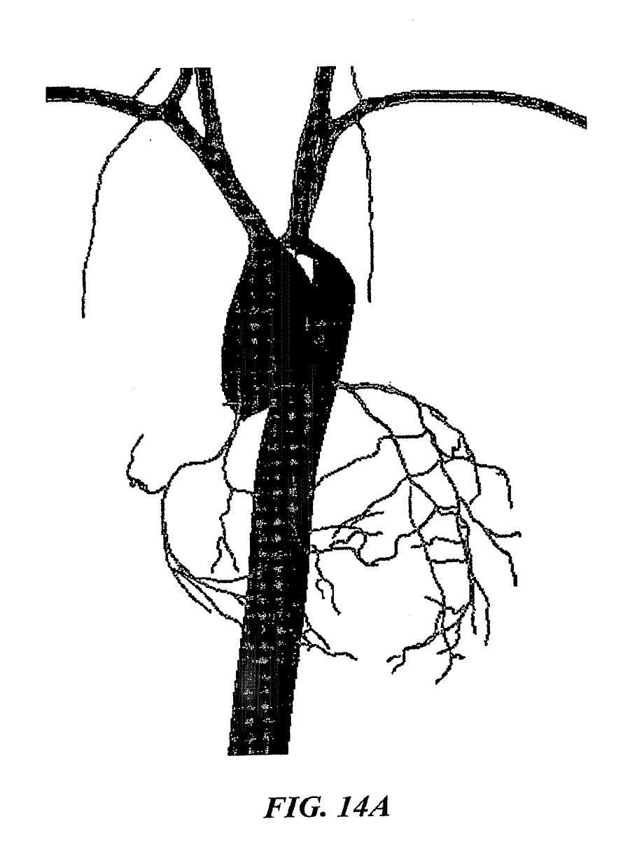

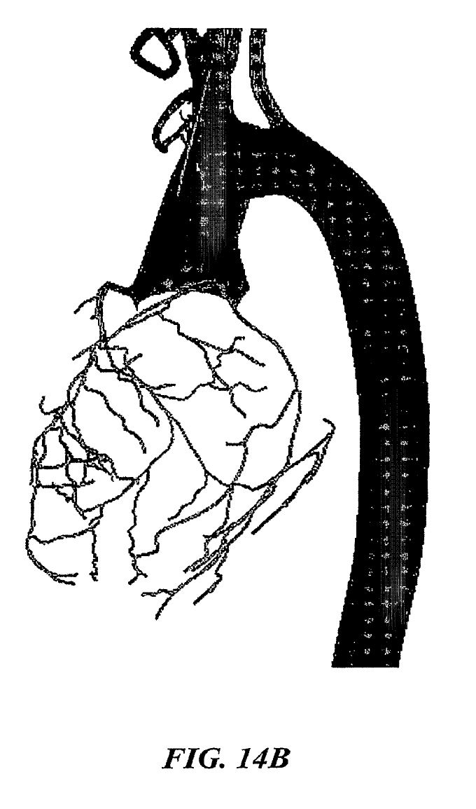

Embodiments of the present invention have also been applied to the coronary arteries shown in FIG. 13. The small vessels around the heart are often the objects of intervention from cardiologists and would therefore be helpful in a training/planning simulator. FIG. 13 shows the high level of details of the three-dimensional surface of the coronary reconstruction, integrated in our simulator, and connected to the aorta.

While the invention is primarily shown and described in conjunction with medical data and applications, it is understood that the invention is applicable to a wide range of applications in which it is desirable to generate a three dimensional surface from an image having a series of lumens. Medical applications include using the generated endoluminal surfaces for interventional radiology, endoscopic surgery, airway management, procedures interacting with endoluminal anatomical structures, catheter simulation, blood/air flow simulation, virtual endoscopy, etc. The generated endoluminal structures can also be used for surgical education and training within a simulated environment, surgical planning or rehearsal, augmenting operating room devices to assist in navigation, imaging or detection, new device prototyping or just-in-time emergency training guides, and embedding anatomical tissue inside the reconstructed model for patient specific device prototyping including stents. Non-medical applications include tree modeling, entertainment, animation movies, architectural design, engine analysis, and pipe networks. Other applications will be readily apparent to one of ordinary skill in the art upon reading the present specification.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method for generating network of endoluminal surfaces, comprising:
defining a set of medial axes for a tubular structure;
defining a series of cross sections along medial axis in the set of medial axes;
generating a connectivity graph of the medial axes;
defining multiple surface representations based upon the graph of the medial axes and the cross sections;
computing a volume defined by a first one of the surface representations;
defining a partition of the medial axis, cross-sections, surface and/or volume representations; and
outputting the network of endoluminal surfaces.

2. The method according to claim 1, wherein the surface representation includes convex and non-convex sets.

3. The method according to claim 1, further including deriving the endoluminal surface from a medical data set.

4. The method according to claim 3, wherein the medical data set is selected from the group consisting of Computer Tomography Angiography (CTA), a Magnetic Resonance Angiography (MRA), CT scan, MRI, and a series of X-ray images.

5. The method according to claim 3, further including deriving the endoluminal surface by:
enhancing contours of the endoluminal structure with anisotropic diffusion;
cleaning the medical data set with masks and morphological operators for dilation and/or erosion to remove bones, artifacts, sinuses and/or skin;
performing segmentation of the endoluminal structure through a level set evolution;
performing skeletonization to obtain centerlines of the endoluminal structure;
performing enhancements of the centerlines;
performing cross-sectional ellipse estimation; and
performing cross section post processing.

6. The method according to claim 5, further including performing skeletonization to generates the set of centerlines, which represent the medical data set as set of three-dimensional lines marking the center of the endoluminal structure.

7. The method according to claim 5, further including performing enhancements of the centerlines by pruning, automatic line connections, and/or smoothing.

8. The method according to claim 5, wherein the ellipse estimation is used to model endoluminal structure cross sections as simple cylindrical structures or ellipsoidal structures.

9. The method according to claim 8, further including using the ellipse estimation information to re-center the centerlines at each step.

10. The method according to claim 3, further including using the centerline and the ellipse data to create the three-dimensional surface to approximate a boundary of the endoluminal structure by constraining bifurcations.

11. The method according to claim 10, further including
tiling the surface of each endoluminal structures;
tiling a junction between the surfaces; and
recursively smoothing the surface.

12. The method according to claim 5, further including extrapolating missing ellipse values using flow computation.

13. The method according to claim 1, further including constructing a unified directed graph for multiple hollow lumen structures.

14. The method according to claim 11, further including using branching angle and vessel ellipses to reduce artifacts when representing the tubular structures.

15. The method according to claim 11, further including joining and/or merging the surface of a branch to another based upon a filet created by end-segment-grouping technique and/or adjacent-quadrant-grouping technique.

16. The method according to claim 11, further including adaptive cross sections distribution using ellipse profile and medial axis curvature profile of a vessel.

17. The method according to claim 14, further including eliminating incorrect bifurcations/junctions and/or reducing a bottle-neck effect and/or eliminating twisting artifacts.

18. The method according to claim 1, further including shrinking and then expanding the ellipse data set if a ratio between parent ellipse and child parent ellipse is greater than a selected value.

19. The method according to claim 1, further including generating generic or patient specific anatomical endoluminal structure representation.

20. The method according to claim 1, further including optimizing the surface for smooth visualization and for contact of the surgical instruments with the internal part of the endoluminal structure.

21. The method according to claim 1, wherein the generated surface is adaptive in complexity and smoothness by increasing a number of triangles composing the surface.

22. The method according to claim 11, further including generating the structured endoluminal model with multiple representations of lumen structures including polygonal surface, subdivision surface representation, implicit surface, medial axis representation, efficient and structured collision detection representation, volumetric representation, and abstract sampling point graph.

23. The method according to claim 1, further including generating information for display to a user from computation and deformation of the tubular structure.

24. The method according to claim 1, further including using the endoluminal surfaces for one or more of interventional radiology, endoscopic surgery, airway management, procedures interacting with endoluminal anatomical structures, catheter simulation, blood/air flow simulation, and virtual endoscopy.

25. The method according to claim 1, further including using the endoluminal structures for surgical education and training within a simulated environment, surgical planning or rehearsal, augmenting operating room devices to assist in navigation, imaging or detection, new device prototyping or just-in-time emergency training guides, and embedding anatomical tissue inside the reconstructed model for patient specific device prototyping including stents.

26. The method according to claim 1, wherein the endoluminal surfaces include one or more of a vascular network, an airway, and an intestinal structure for a human and/or animal.

27. The method according to claim 1, further including using the endoluminal structures for modeling, simulation, entertainment, animation, architectural design, and analysis of engines, pipe networks, trees, and branching plants.

28. The method according to claim 1, further including defining endoluminal surfaces optimized for smooth visualization, real time collision detection and response, deformation, and/or flow computation.

29. A method, comprising:
receiving a data set having a luminal structure;
segmenting the data set by:
filtering the data set;
performing skeletonization of the filtered data set;
determining endoluminal centerlines from the skeletonized data set to form a structure;
estimating ellipses for the structure; and
outputting the structure with estimated ellipses.

30. The method according to claim 29, further including refining the skeletonization of the structure from the estimated ellipses.

31. A method, comprising:
receiving a segmented data set;
reconstructing a luminal network from the segmented data set by:
generating a graph from the data set;
generating a triangular mesh from the data set;
generating a quadrilateral lattice from the data set;
generating a NURB surface from the data set;
generating an implicit surface from the data set;
generating a volume representation from the data set;
defining a partition of medial axes;
defining a partition of cross-sections;
defining a partition of the triangular mesh;
defining a partition of the quadrilateral lattice;
defining a partition of the NURB surface;
defining a partition of the implicit surface;
defining a partition of the volume representation; and
outputting the multiple representations and the partitions of the luminal network structures.
